(19) United States
(12) Patent Application Publication
(10) Pub. No.: US 2016/0292307 A1
(43) Pub. Date: Oct. 6, 2016

(54) TEMPORAL LOGIC ROBUSTNESS GUIDED TESTING FOR CYBER-PHYSICAL SYSTEMS

(71) Applicant: ARIZONA BOARD OF REGENTS ON BEHALF OF ARIZONA STATE UNIVERSITY, Scottsdale, AZ (US)

(72) Inventors: Georgios FAINEKOS, Phoenix, AZ (US); Bardh HOXHA, Tempe, AZ (US); Houssam ABBAS, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 15/034,979

(22) PCT Filed: Nov. 6, 2014
(86) PCT No.: PCT/US14/64310

§ 371 Date: May 6, 2016

Related U.S. Application Data
(60) Provisional application No. 61/900,866, filed on Nov. 6, 2013.

(51) Int. Cl. G06F 17/50; G06F 17/18

(52) U.S. Cl. CPC G06F 17/50; G06F 17/18; G06F 2217/10

(57) ABSTRACT

Embodiments of model-based system design with model verification are disclosed. An embodiment includes receiving a model for a system and at least one specification for the system. In some embodiments, the system determines at least one of a minimum expected robustness value and a maximum expected robustness value for a region of a search space of the model with respect to the at least one specification. The model may be modified based on the determined minimum or maximum expected robust ness value.

### CROSS-REFERENCE TO RELATED APPLICATIONS

This application claims the benefit of U.S. Provisional Patent Application No. 61/900,866 entitled “GUIDED TEMPORAL LOGIC TESTING OF CYBER-PHYSICAL SYSTEMS,” filed Nov. 6, 2013, which is expressly incorporated by reference herein in its entirety.

### GOVERNMENT LICENSE RIGHTS

This invention was made with government support under contract 1116136 awarded by the National Science Foundation and 1017074 awarded by the National Science Foundation. The government has certain rights in the invention.

### FIELD OF THE DISCLOSURE

This disclosure relates to methods and apparatuses for verification of system models, and more particularly relates to temporal logic robustness guided testing for cyber-physical systems.

### BACKGROUND

Stochasticity is inherent in many systems. Stochasticity might arise as the result of actuator effects, sensor readings, rate of arrivals, component failure rates, unexpected transient behavior, etc. Even though testing is a commonly used approach to verify systems and system models, testing and verification relies on the ability of the engineers to write out test cases that cover all the behaviors of the system where the expected failures can occur. Writing out all cases is usually a very difficult task because the systems and their models are often extremely complex. Examples of complex system models include high fidelity system models, such as internal combustion and hybrid engine models. Furthermore, in many cases, system failures can occur in unexpected operating conditions and inputs.

One type of system that exhibits stochasticity is a Cyber-Physical System (CPS). Many CPSs are safety critical systems. Some examples are aircrafts, automobiles, medical devices, and the like. As these systems become more integrated with software, the mistakes and errors can become harder to detect and failures can become very expensive in terms of both human lives and economic costs. Furthermore, due to actuator effects, sensor readings, rate of arrivals, and component failure rates these systems exhibit stochastic behavior as well.

### BRIEF SUMMARY

The design of a system may be improved by designing the system using a model-based design process that includes model verification. According to one embodiment, a method for model-based system design with model verification may include receiving a model for a system and receiving at least one specification for the system. The method may also include determining at least one of a minimum expected robustness value and a maximum expected robustness value for a region of a search space of the model with respect to the at least one specification, and modifying the model based on the determined minimum expected robustness value or maximum expected robustness value.

According to another embodiment, a computer program product may include a non-transitory computer-readable medium. The medium may include instructions which, when executed by a processor of a computing system cause the processor to perform the steps of receiving a model for a system and receiving at least one specification for the system. In some embodiments, the medium may further include instructions to cause the processor to perform the steps of determining at least one of a minimum expected robustness value and a maximum expected robustness value for a region of a search space of the model with respect to the at least one specification, and modifying the model based on the determined minimum expected robustness value or maximum expected robustness value.

According to yet another embodiment, an apparatus may include a memory and a processor coupled to the memory. The processor may be configured to execute the steps of receiving a model for a system and receiving at least one specification for the system. In some embodiments, the processor may be further configured to execute the steps of determining at least one of a minimum expected robustness value and a maximum expected robustness value for a region of a search space of the model with respect to the at least one specification, and modifying the model based on the determined minimum expected robustness value or maximum expected robustness value.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments.

FIG. 1 is a schematic block diagram illustrating a model-based design process with model verification according to one embodiment of the disclosure.

FIG. 2 is an illustration showing an Expected Robustness Guided Monte Carlo Algorithm (ERGMC) according to one embodiment of the disclosure.

FIG. 3 is a schematic block diagram illustrating a solution to finding the samples on the search space that give the minimum expected robustness value for a metric temporal logic (MTL) specification according to one embodiment of the disclosure.

FIG. 4 is an illustration showing another embodiment of an Expected Robustness Guided Monte Carlo Algorithm (ERGMC) according to one embodiment of the disclosure.

FIG. 5 is a flow chart illustrating a method for model-based system design with model verification according to one embodiment of the disclosure.

FIG. 6 is a block diagram illustrating a computer network according to one embodiment of the disclosure.

FIG. 7 is a block diagram illustrating a computer system according to one embodiment of the disclosure.

### DETAILED DESCRIPTION

The design of a system, such as a Stochastic CPS (SCPS), may be improved by using a model-based design process with model verification and modification to design the system. For example, general benefits of using a model-based design process with model verification and modification to design a system include a reduced number of hours from initial design to market, a reduced need for physical prototypes, the ability to use analysis and synthesis methods for design space exploration, automatic code generation, and the like. In addition, with a model-based design process, most of the work may be moved from debugging the prototype implementation of the software to verifying the correctness of the model, where the correctness of a model may be judged with respect to a number of formal specifications. Although specific examples of systems for modeling are described, the methods described herein may be applied to any system or stochastic system. For example, the methods described herein may be applied to a system for modeling continuous-time birth and death processes, a vehicle automatic transmission system, a fuel controller system, and a generic engine system.

By utilizing the notion of robustness for MTL specifications as disclosed herein, quantification of the robustness with which a modeled system trajectory satisfies the MTL specification may be made possible. Large positive quantification values may indicate that the system is robustly correct, while negative values may imply falsification of the specification. Thus, the verification problem for SCPS may be reduced to a problem of finding a global minimizer for the expected temporal logic robustness because the minimum expected robustness values may provide a good indication of system parameters that may cause the system to fail. If the expected MTL robustness on a global minimizer is positive, then the system is correct in the expected sense. Moreover, statistics can be collected in order to assess the probability of satisfaction.

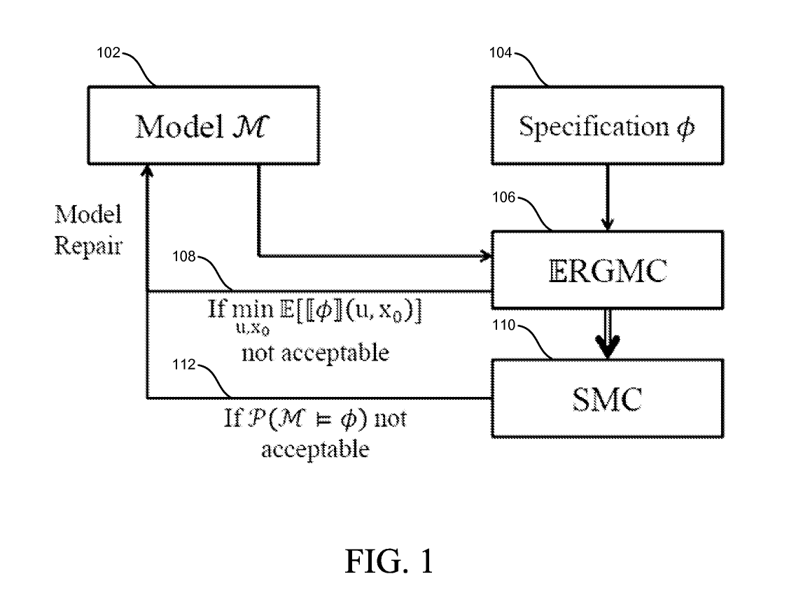

FIG. 1 is a schematic block diagram illustrating a model-based design process with model verification and modification according to one embodiment of the disclosure. A model 102 for a system and at least one specification 104 defining properties for the system may be received. For example, in some embodiments, a processing device on which the model-based design process with model verification and modification is executed may receive the model for the system and the specification. In some embodiments, the specification 104 may include an MTL specification. In one embodiment, the specification 104 may be provided by a designer of the system, and the specification 104 may include some variability to account for the fact that the specification may be provided prior to the development of the system. According to an embodiment, an Expected Robustness Guided Monte Carlo (ERGMC) module 106 executed by a processor may process the model 102 and the specification 104 to determine a minimum expected robustness value for a region of a search space of the model 102 with respect to the specification 104. In some embodiments, a plurality of specifications may be obtained, and the ERGMC module 106 may process the model 102 and each specification 104 of the plurality of specifications to determine a minimum expected robustness value for a region of a search space of the model 102 with respect to each specification of the plurality of received specifications. In addition, according to some embodiments, the ERGMC module 106 may determine the minimum expected robustness value with finite time guarantees to ensure that the processing is terminated after a finite number of iterations.

In addition, in some embodiments, the minimum expected robustness value may correspond to a worst expected behavior for the system. According to some embodiments, the worst case system behavior may be returned to a user of the system model so that the user can debug the system or the model for the system. The ability to debug the system based on a determined worst case behavior is significant because debugging within the design process is not possible in prior art systems when using probabilistic verification techniques or even statistical model checking.

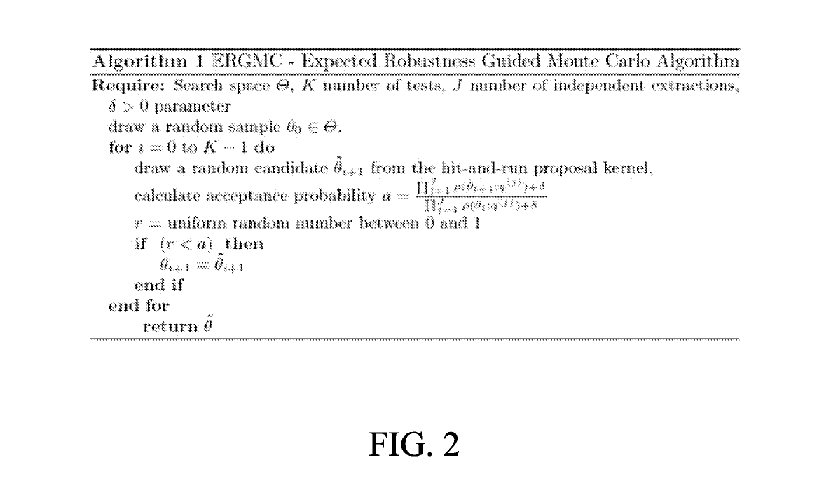

FIG. 2 is an illustration showing an ERGMC algorithm executed according to one embodiment of the disclosure. For example, the algorithm illustrated in FIG. 2 may illustrate the internal logic performed by the ERGMC module 106 illustrated in FIG. 1. According to an embodiment, the ERGMC algorithm may explore the search space, which may be composed of the range of the initial conditions and the range of the input parameters. In some embodiments, the search space may be the domain of the function to be optimized, and the search space may be composed of the range of the initial conditions and the range of the input parameters. The range of input parameters and initial conditions may be received as part of the model. In one embodiment, hypercubes may be used to define the range of the initial conditions and input parameters, with the goal being to find the maximum or minimum expected robustness values. Although FIG. 2 illustrates an ERGMC algorithm finding a maximum expected robustness value, the ERGMC algorithm illustrated in FIG. 2 may be switched to find a minimum expected robustness value by multiplying the cost function by −1.

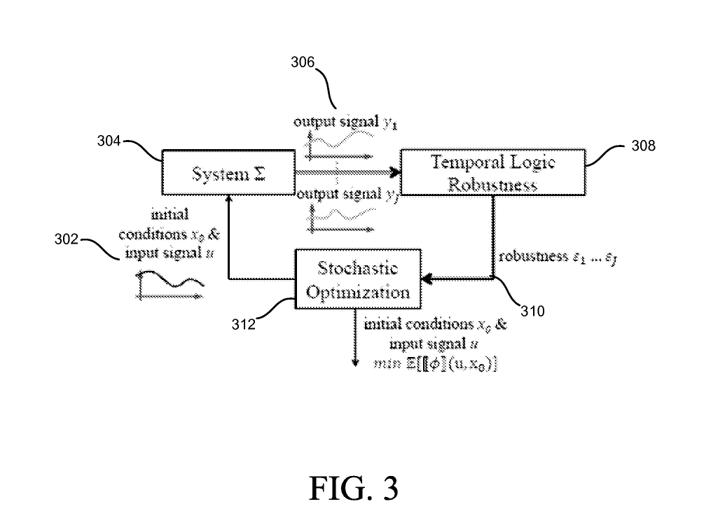

FIG. 3 is a schematic block diagram illustrating a solution to finding the samples on the search space that give the minimum expected robustness value for a MTL specification according to one embodiment of the disclosure. In some embodiments, the schematic block diagram illustrated in FIG. 3 may illustrate, in block diagram form, an embodiment of the algorithm illustrated in FIG. 2 in mathematical form. In other words, both FIG. 2 and FIG. 3 may illustrate, in different forms, different embodiments of the internal processing logic of the ERGMC module 106 illustrated in FIG. 1. In one embodiment, the sampler 302 may produce a point x₀ from the set of initial conditions and a vector of parameters λ that characterize the control input signal u. The initial conditions, the parameters, and the input signal may be passed to a system simulator 304, which may output a vector of execution traces 306 (e.g., trajectories and timing functions for the system). The vector of traces 306 may be analyzed by the MTL robustness analyzer 308, which may output a vector of robustness values 310 for each trace representing the best estimate for the parameter found so far. In some embodiments, the computed robustness scores may be used by the stochastic optimizer 312 to decide on a next input to analyze.

In some embodiments, the iterative process illustrated in FIG. 3 may be repeated until a termination condition is met. For example, according to an embodiment, the process illustrated in FIG. 3 may terminate after a maximum number of tests have been performed to meet finite time guarantees. According to another embodiment, other termination points are also possible. For example, in one embodiment, a number of tests to perform may be calculated based on the system being modeled or the system simulator 304. In addition, in another embodiment, a real-time determination of how many tests to carry out may be performed based on criteria defined for the design process.

Returning to FIG. 1, after the ERGMC module 106 processes the model 102 and the specification 104 to determine a minimum expected robustness value, the model 102 may be modified based on the determined minimum expected robustness value, as indicated at path 108. For example, according to an embodiment, if the minimum expected robustness value is low or negative, then the model 102 may be modified/repaired, as indicated at path 108. In some embodiments, an expected robustness value that is too low or negative may indicate that the specification 104 failed. For example, in some embodiments, a negative expected robustness value may indicate that the specification is not satisfied in the expected sense. Values for which the expected robustness value may be considered too low may be determined by a system developer and may depend on both the model and specification.

According to another embodiment, if the determined minimum expected robustness value is satisfactory, then the region of the search space of the model associated with the satisfactory determined minimum expected robustness value may be processed with a statistical model checking (SMC) module, such as at block 110, to calculate the probability that the model behavior with the worst expected robustness of model 102 satisfies the specification 104. In some embodiments, statistical model checking may be performed to estimate the correctness of a stochastic model through statistical techniques. As an example, and not limitation, statistical model checking techniques may utilize simulation data from the model in conjunction with theoretical results from statistics to estimate the probability that the model behavior with the worst expected robustness satisfies a specification and with what confidence level the model satisfies the specification.

In some embodiments, the model 102 may undergo further modifications/repairs if the calculated probability is too low, as indicated at path 112. According to an embodiment, whether the probability is considered too low may depend on the application domain and the specification. As an example, and not limitation, in some embodiments the model may be derived from a safety-critical system, and therefore the probability that the specification fails may be required to be very low, such as less than 10⁻⁶. Other application domains, such as models derived from systems that are not safety-critical, may not require such low probability thresholds.

According to another embodiment, if the minimum expected robustness value and the corresponding calculated probability level meet a predefined requirement, then the model 102 may be accepted. In some embodiments, the predefined requirements may be set by an engineering team in accordance with their organizational goals.

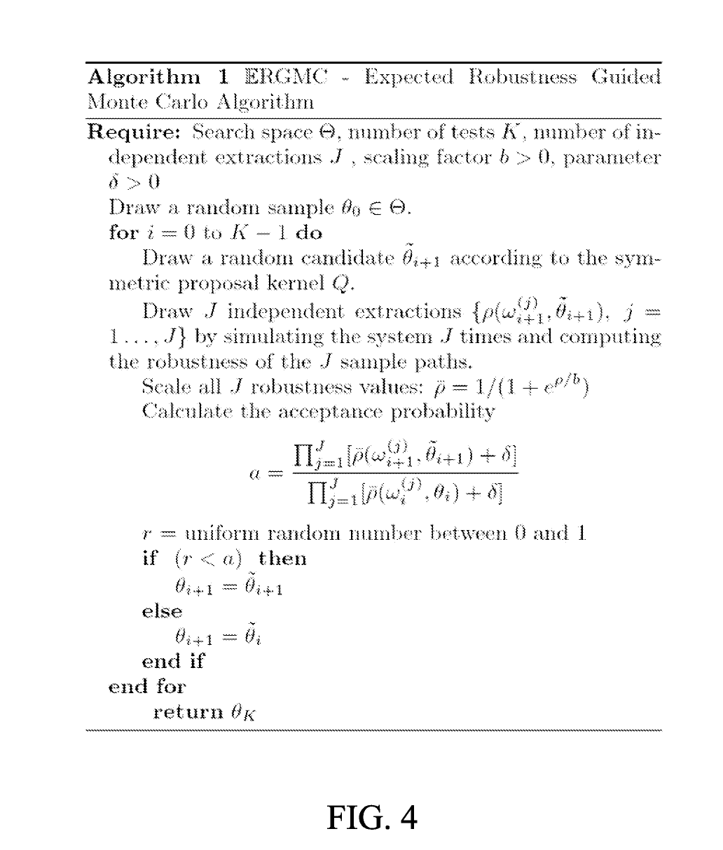

FIG. 4 is an illustration showing another embodiment of an ERGMC algorithm according to one embodiment of the disclosure. As one distinction, whereas the ERGMC algorithm illustrated in FIG. 2 draws a random candidate from the hit-and-run proposal kernel, the ERGMC algorithm illustrated in FIG. 4 draws a random candidate according to the systematic proposal kernel.

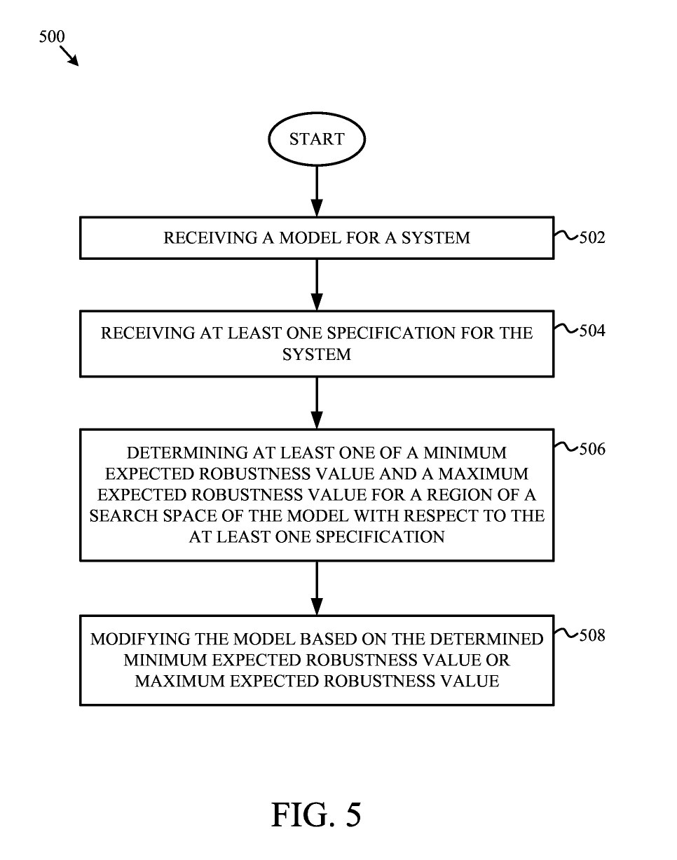

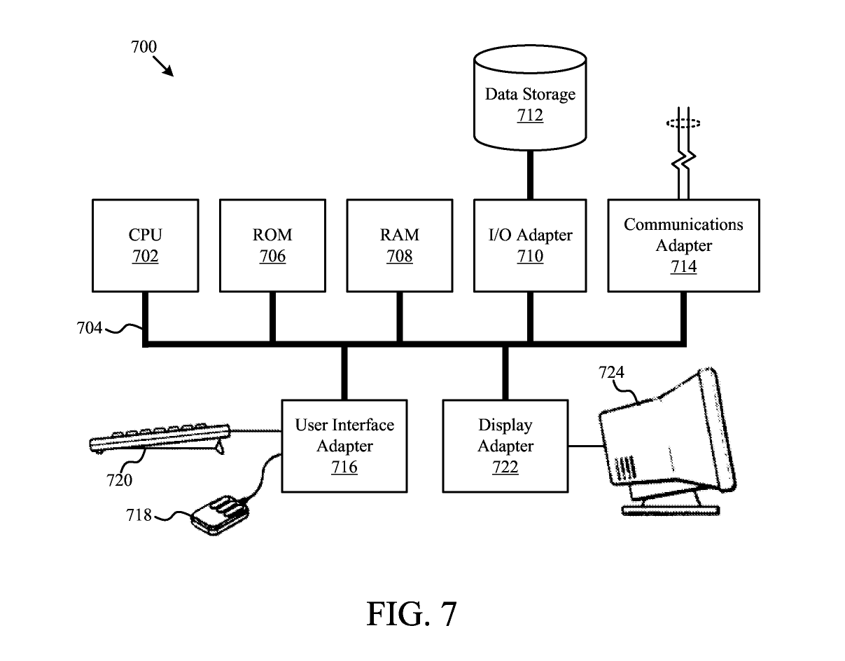

FIG. 5 is a flow chart illustrating a method for model-based system design with model verification according to one embodiment of the disclosure. Embodiments of method 500 may be implemented with the embodiments of this disclosure described with respect to FIGS. 1-4 and 6-7. Specifically, method 500 includes, at block 502, receiving a model for a system. At block 504, method 500 includes receiving at least one specification for the system. For example, a processor implementing embodiments of this disclosure, such as processor 702 of FIG. 7 executing an ERGMC module, may be configured to receive the model and specification. In some embodiments, the specification 104 may include a MTL specification.

At block 506, method 500 may include determining at least one of a minimum expected robustness value and a maximum expected robustness value for a region of a search space of the model with respect to the at least one specification. For example, a processor implementing embodiments of this disclosure, such as processor 702 of FIG. 7 executing an ERGMC module, may also be configured to determine at least one of a minimum expected robustness value and a maximum expected robustness value for a region of a search space of the model with respect to the at least one specification. In some embodiments, the minimum and/or maximum expected robustness values may be determined with finite-time guarantees. In addition, in some embodiments, the minimum expected robustness value may correspond to a worst expected behavior for the system.

At block 508, method 500 also includes modifying the model based on the determined minimum expected robustness value or maximum expected robustness value. For example, according to an embodiment, the model may be modified when the minimum expected robustness value is low or negative. In some embodiments, a processing device implementing embodiments of this disclosure, such as processor 702 of FIG. 7, may be configured to modify the model based on the determined minimum expected robustness value or maximum expected robustness value

In some embodiments, in addition to determining minimum and/or maximum expected robustness values, a probability that the model behavior with the worst expected robustness satisfies the received specification may also be calculated, and the model may be subsequently modified based on the calculated probability. For example, according to an embodiment, the model may be modified when the calculated probability of the model behavior with the worst expected robustness satisfying the specification is low. According to some embodiments, when the minimum expected robustness value and the corresponding calculated probability meet predefined requirements, the model for the system may be accepted and used as a sufficient model of the system.

In some embodiments, this disclosure may represent a framework for robustness guided model checking of systems, such as a SCPS. The framework may utilize the theory of robustness of metric temporal logic specifications to convert the verification problem into an optimization problem of expected system robustness, and the optimization problem may be solved by utilizing Monte Carlo methods that provide finite time guarantees. According to an embodiment, the robustness metric may provide a real number that indicates how distant a trajectory of a SCPS is to a set defined for the falsifying specification. As opposed to a true or false result, the robustness metric value may indicate not only if the specification holds but also may contain information about how far or close the trajectory is to falsifying or satisfying the specification.

According to an embodiment, even if verification with the desired probabilistic guarantees cannot be achieved, embodiments of the model-based design process with model verification and modification disclosed herein may still provide a best effort automatic test generation scheme. The best effort automatic test generation scheme may be guided by the MTL robustness metric utilized in this disclosure.

Although the present disclosure thus far has related to temporal logic robustness guided testing for cyber-physical systems, the embodiments of the present disclosure relate equally, with slight modification, to temporal logic robustness guided testing for cyber-physical systems, such as systems that exhibit little or no randomness. For example, in some embodiments, to apply the embodiments of the present disclosure to deterministic systems, rather than focusing on the minimum or maximum expected robustness, the focus for deterministic system applications may be on the minimum and maximum robustness. In addition, in some embodiments, the embodiments of the present disclosure may be applied to deterministic systems without performing statistical model checking.

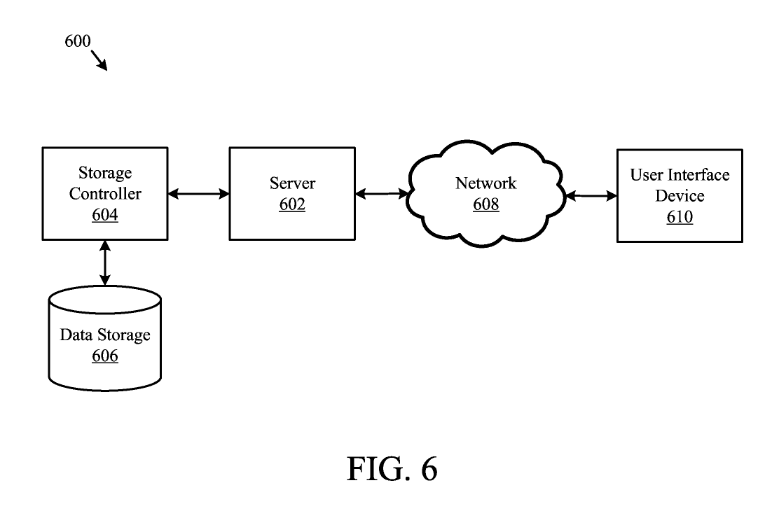

FIG. 6 illustrates a computer network 600 for a model-based system design process with model verification according to one embodiment of the disclosure. The system 600 may include a server 602, a data storage device 606, a network 608, and a user interface device 610. In one embodiment, the server 602 may also be a hypervisor-based system executing one or more guest partitions hosting operating systems. In a further embodiment, the system 600 may include a storage controller 604, or a storage server configured to manage data communications between the data storage device 606 and the server 602 or other components in communication with the network 608. In an alternative embodiment, the storage controller 604 may be coupled to the network 608.

In one embodiment, the user interface device 610 may be referred to broadly and may be intended to encompass a suitable processor-based device such as a desktop computer, a laptop computer, a personal digital assistant (PDA) or tablet computer, a smartphone or other mobile communication device having access to the network 608. In a further embodiment, the user interface device 610 may access the Internet or other wide area or local area network to access a web application or web service hosted by the server 602 and may provide a user interface for enabling a user to enter or receive information.

The network 608 may facilitate communications of data between the server 602 and the user interface device 610. The network 608 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

FIG. 7 illustrates a computer system 700 adapted according to certain embodiments of the server 602 and/or the user interface device 610. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations as described herein. The CPU 702 may execute the various logical instructions according to the present embodiments.

The computer system 700 may also include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data, and both the RAM 708 and the ROM 706 may be randomly accessed.

The computer system 700 may also include an input/output (I/O) adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 724, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710. The communications adapter 714 may be adapted to couple the computer system 700 to the network 608, which may be one or more of a LAN, WAN, and/or the Internet. The user interface adapter 716 couples user input devices, such as a keyboard 720, a pointing device 718, and/or a touch screen (not shown) to the computer system 700. The display adapter 722 may be driven by the CPU 702 to control the display on the display device 724. Any of the devices 702-722 may be physical and/or logical.

The applications of the present disclosure are not limited to the architecture of computer system 700. Rather the computer system 700 is provided as an example of one type of computing device that may be adapted to perform the functions of the server 602 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 700 may be virtualized for access by multiple users and/or applications.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for development and verification of system models, comprising:
receiving, by a processor, a model for a system;
receiving, by the processor, at least one specification for the system;
determining, by the processor, at least one of a minimum expected robustness value and a maximum expected robustness value for a region of a search space of the model with respect to the at least one specification; and
modifying, by the processor, the model based on the determined minimum expected robustness value or maximum expected robustness value.

2. The method of claim 1, further comprising calculating a probability that the model behavior with the worst expected robustness satisfies the at least one specification.

3. The method of claim 2, wherein modifying the model comprises modifying the model when at least one of:
the minimum expected robustness value is low or negative; and
the calculated probability of the model behavior with the worst expected robustness satisfying the specification is low.

4. The method of claim 3, further comprising accepting the model when the minimum expected robustness value and the corresponding calculated probability meet predefined requirements.

5. The method of claim 1, wherein the at least one specification comprises at least one metric temporal logic (MTL) specification.

6. The method of claim 1, wherein the minimum expected robustness value corresponds to the worst expected system behavior.

7. The method of claim 1, further comprising determining the at least one of the minimum expected robustness value and maximum expected robustness value with finite-time guarantees.

8. A computer program product, comprising:
a non-transitory computer-readable medium comprising instructions which, when executed by a processor of a computing system, cause the processor to perform the steps of:
receiving a model for a system;
receiving at least one specification for the system;
determining at least one of a minimum expected robustness value and a maximum expected robustness value for a region of a search space of the model with respect to the at least one specification; and
modifying the model based on the determined minimum expected robustness value or maximum expected robustness value.

9. The computer program product of claim 8, wherein the medium further comprises instructions to cause the processor to perform the step of calculating a probability that the model behavior with the worst expected robustness satisfies the at least one specification.

10. The computer program product of claim 9, wherein modifying the model comprises modifying the model when at least one of:
the minimum expected robustness value is low or negative; and
the calculated probability of the model behavior with the worst expected robustness satisfying the specification is low.

11. The computer program product of claim 10, wherein the medium further comprises instructions to cause the processor to perform the step of accepting the model when the minimum expected robustness value and the corresponding calculated probability meet predefined requirements.

12. The computer program product of claim 8, wherein the at least one specification comprises at least one metric temporal logic (MTL) specification.

13. The computer program product of claim 8, wherein the minimum expected robustness value corresponds to the worst expected system behavior.

14. The computer program product of claim 8, wherein the medium further comprises instructions to cause the processor to perform the step of determining the at least one of the minimum expected robustness value and maximum expected robustness value with finite-time guarantees.

15. An apparatus, comprising:
a memory; and
a processor coupled to the memory, the processor configured to execute the steps of:
receiving a model for a system;
receiving at least one specification for the system;
determining at least one of a minimum expected robustness value and a maximum expected robustness value for a region of a search space of the model with respect to the at least one specification; and
modifying the model based on the determined minimum expected robustness value or maximum expected robustness value.

16. The apparatus of claim 15, wherein the processor is further configured to execute the step of calculating a probability that the model behavior with the worst expected robustness satisfies the at least one specification.

17. The apparatus of claim 16, wherein modifying the model comprises modifying the model when at least one of:
the minimum expected robustness value is low or negative; and
the calculated probability of the model behavior with the worst expected robustness satisfying the specification is low.

18. The apparatus of claim 17, wherein the processor is further configured to execute the step of accepting the model when the minimum expected robustness value and the corresponding calculated probability meet predefined requirements.

19. The apparatus of claim 15, wherein the at least one specification comprises at least one metric temporal logic (MTL) specification.

20. The apparatus of claim 15, wherein the minimum expected robustness value corresponds to the worst expected system behavior.

21. The apparatus of claim 15, wherein the processor is further configured to execute the step of determining the at least one of the minimum expected robustness value and maximum expected robustness value with finite-time guarantees.
